(19) United States
(12) Patent Application Publication
(10) Pub. No.: US 2014/0253921 A1
(43) Pub. Date: Sep. 11, 2014

(54) SPECTROSCOPIC SYSTEMS AND METHODS

(71) Applicant: QIUSHUI CHEN, Andover, MA (US)

(72) Inventor: QIUSHUI CHEN, Andover, MA (US)

(21) Appl. No.: 13/788,515

(22) Filed: Mar. 7, 2013

(51) Int. Cl. G01J 3/28

(52) U.S. Cl. CPC G01J 3/28
USPC 356/416

(57) ABSTRACT

The present invention provides a spectroscopic system having a first tunable filter module, a second tunable filter module, an optical detector and a signal processing unit. The first tunable filter module includes a first tunable filter and corresponding control unit. The second tunable filter module includes a second tunable filter and corresponding control unit. The second tunable filter is configured in series with the first tunable filter, and the second tunable filter is selected so that the free spectral range of the second tunable filter matches the half-peak width of the first tunable filter. The optical detector is configured to receive wide wavelength bands of electromagnetic radiation transmitted through the first tunable filter and the second tunable filter and to generate one or more electrical signals indicative of electromagnetic radiation intensity as a function of wavelength.

### THE TECHNICAL FIELD

The present invention relates to the art of spectrometry, spectroscopic instruments. Specifically, the present invention relates to a novel approach utilizing tunable filter to increase spectrometer resolution by as much as F times, where F is the finesse of tunable filter. The focus of the invention is in utilization of the above method to significantly increase spectral resolution of a wide range spectrometer. The invention enables creation of a simple, reliable, rugged, inexpensive and portable system for high resolution spectroscopy applications.

### BACKGROUND

The present invention relates to a spectroscopic system having a significantly improved resolution. It is primarily concerned with the desire to combine features of high resolution, no mechanical moving parts, compact design and easy industrial deployment.

Most spectrometers are based on one of the following three technologies: interferometer based Fourier Transform technology, dispersion based technology with a detector array, and tunable filter based technology with serial scanning.

Fourier Transform based technology is considered to have the advantages of high resolution, wide spectral range and multiplexing. Fourier Transform based spectrometers are, however, inherently large and expensive, and they are typically not fit for rugged industrial deployment.

Dispersive instruments employing gratings or acoustic optics can also achieve multiplexing. The resolution of such instruments is, however, ultimately limited by the number of detector elements in the detector array. A larger number of detector elements are needed to achieve higher resolution, and a larger number of detector elements also lead to larger size of such instruments. The size of such instruments is typically larger than tunable Fabry-Perot filter based instrument of comparable resolution. The large number of detector elements also significantly increases the cost and decreases the ruggedness of such instruments. For the near-infrared (NIR), or longer wavelength, regions where the detector technology has not achieved cost advantage of mass production, the cost disadvantage becomes a major concern. For visible light region, such cost disadvantage comes from the charge coupled device (CCD).

Optical spectrometers are systems that enable the measurement of optical intensity at specific wavelengths or spectral bands. Optical spectrometers are commonly used in certain chemical and biological analysis devices to detect, identify, or quantify chemical or biological species. Raman, fluorescence, absorption and reflectance spectrometers are among some of the most commonly used methods to optically analyze chemical or biological samples.

Raman spectroscopy is highly sensitive to subtle differences in chemical composition and crystallographic structure. There are two types of Raman transitions. Upon the collision with a molecule a photon may lose some of its energy, this is known as Stokes radiation. In what is known as anti-Stokes radiation, the photon gains energy. This happens when the incident photon is scattered by a vibrationally excited molecule, as a result, the scattered photon gains a higher frequency. Each compound has its own unique Raman spectrum fingerprint.

One of today's commonly used optical spectrometers is based on wavelength scanning, which can be achieved by either grating or filter. A wavelength scanning instrument acquires one wavelength band at a given time, such examples include monochomators, discrete filters spinning wheel, and tunable filters (tunable through various techniques such as mechanical tilting, thermal variation, opto-acoustical and opto-electrical variation).

There are generally two common methods of sampling and acquiring radiation signal using wavelength scanning devices, one being continuous-scan, another being step-and-scan. For continuous-scan, the wavelength-selecting device, such as a monochromator, is controlled to continuously vary the output wavelength. For step-and-scan, the wavelength-selecting device moves in discrete steps, samples one narrow wavelength band at a time, integrates(averages) the signal in that narrow wavelength band, then reconstructs the signal as discrete points. Step-and-scan is preferable over continuous-scan because step-and-scan tends to have a much higher signal-to-noise ratio (SNR).

Many chemical and biological analysis today requires high resolution spectroscopic devices, measuring trace components vary accurately and reproducibly, down to parts-per-million, or even parts-per-billion levels. In addition, many chemical and biological analyses require wide spectral or wavelength coverage due to the need to measure multiple species and the need to compensate for signal interference arising from the presence of other species in sample.

While in principle high resolution does not necessarily contradict wide spectrum coverage, in practice, higher resolution is usually achieved at the cost of spectrum coverage, and wider spectrum at the cost of resolution. Accordingly, there is a need for spectroscopic devices that achieve high resolution and wide spectrum coverage at the same time without significantly increase the number of costly detectors.

Tunable filter based instruments, especially those solid-state Fabry-Perot tunable filter based, have the inherent advantages of ultra-compactness, ruggedness, low power consumption and resolution comparable to Fourier Transform based instruments.

Spectroscopic systems employing a plurality of filters have been described and reported to include additional wavelength bands and to extend spectral coverage. U.S. Pat. No. 4,040,747 to Webster discloses an invention which employs multiple filters on a rotating wheel. This invention and other inventions (See, e.g., U.S. Pat. No. 7,099,003, U.S. Pat. No. 5,268,745) with mechanical moving parts(such as grating, mechanical chopper, gear-reduction mechanism, rotating filter, tiltable filter, spinning wavelength-selection device) all have inherent drawbacks of large size, slow response and mechanical instability(which makes them prone to mechanical vibrations). Accordingly, there is a need for compact and rugged spectroscopic devices that are suitable for industrial deployment. U.S. Pat. No. 5,357,340 to Zochbauer discloses an invention that employs two Fabry-Perot filters in which the thickness of the first Fabry-Perot filter is set to a given value and the thickness of the second Fabry-Perot filter is modulated to produce a resultant interferogram as a function of the thickness of the second Fabry-Perot filter. The additional filter is not utilized in collaboration with the first filter to increase resolution and widen spectral range. Accordingly, there is a need for spectroscopic devices that employ multiple filters working in collaboration with each other to fully exploit each individual filter's resolution and spectral range properties.

High resolution spectrometers have been designed to achieve improved resolution. U.S. Pat. No. 4,902,136, for example, discloses an arrangement for high resolution spectroscopy including a spatially or chronologically tunable interference filter with a wavelength selective diode array having diode elements of different spectral sensitivity arranged side-by-side, wherein the spacing of the transmission regions of the inference filter corresponds to the spacing of the sensitivity maxima of the individual detector elements. The interference filter is either wedge, or plane parallel, in the latter case, it is either electro-mechanically tunable, thermally tunable, or electrically tunable. The diode array may be integrated with the interference filter in some embodiments.

U.S. Pat. No. 5,305,077 discloses a high-resolution spectroscopy system with interference filter, wherein different rays of the focused beam of light impinge on the filter at different angles and for each angle the filter is tuned to a different wavelength. One disadvantage of such system is that angular measurement elements tend to be expensive.

With the development of micro-electrical mechanical system (MEMS) technology, integrated spectroscopy systems become possible. In U.S. Pat. No. 7,061,618 B2, such integrated systems are disclosed. In some examples, integrated tunable detectors, using one or multiple Fabry-Perot tunable filters, are provided, in other examples, integrated tunable sources are provided. Tunable source combines one or multiple diodes and a Fabry-Perot tunable filter or etalon. Such technology makes compact, robust and high performance spectrometer possible.

Second stage spectroscopic analysis can be added to existing systems to increase resolution. Ultra high resolution is achieved with the disclosure in U.S. Pat. App. Pub. No. 2007/0159626 A1, wherein the input light beam is first spread along a line, then in the second stage analysis, is further spread into two dimensional array. A two dimensional detector array is implemented to receive the two dimensional spectral signal. U.S. patent publication Pub. No. US2010/0290045's disclosure is mainly concerned with rotating filters.

### SUMMARY OF INVENTION

Presented herein is a compact, rugged, inexpensive spectroscopic system with increased resolution and widened spectral range. The system features multiple tunable filters well-matched and calibrated with each other to fully utilize each individual filter's resolution and spectral range to achieve high overall resolution and wide overall spectral range. The system is controlled by electronic signal and does not have any mechanical moving parts.

Presented herein also is a method of selecting and matching multiple tunable filters to achieve high resolution and wide spectral range spectroscopy, and a method to reconstruct the resulting spectrum.

In certain preferred embodiment, the spectrometer features two well-matched and well-calibrated tunable filters arranged in series, through which light passes before being collected by photo a detector. Such tunable filters can be, for example, opto-electric tunable filters. To achieve wide spectral range, the first filter is typically selected to have a wide free spectrum range (FSR) that covers the desired target spectral range of intended measurements. When appropriately modulated, the first filter scans through the target spectral range. The resolution achieved by the first filter is limited by the half-peak width of its own spectrum peaks. To achieve higher resolution beyond the half-peak width of the first filter, a second filter is selected to have a FSR that matches the half-peak width (w) of the first filter, so that when appropriately modulated, the second filter scans through the spectral range within half-peak width of the first filter to obtain more sampling points. Finess (F) of a tunable filter is defined by F=FSR/w, which describes the number of peaks contained within a free spectral range. The number of data points within the FSR of the first filter is increased F (finess of the second filter) times, accordingly, the overall resolution is increased F times. The selection of the second filter should consider the target resolution desired by the spectrometer and the finess of the second filter. The second filter should have a resolution (which is determined by the half-peak width of the second filter) higher than the target resolution of the spectrometer, and at the same time, and at the same time the second filter should have a free spectral range that is capable of scanning through the half-peak width of the first filter. A pair of control signals determines the fine-tuned wavelength being sampled through a well-designed algorithm. In the case of opto-electric tunable filters, such a pair of control signals is a pair of control voltages.

In certain preferred embodiment, the first tunable filter is a Lyot filter and the second tunable filter is a Fabry-Perot filter.

In certain preferred embodiment, three tunable filters are used. Those three filters are well-matched with each other and well calibrated to achieve high resolution and wide spectral range. The first filter is selected to have a wide free spectral range (FSR1) that covers the target spectral range of the overall spectrometer, the third filter is selected to have a half-peak width (w3) that matches the target resolution of the overall spectrometer. Then the second filter is carefully selected to have FSR2 that covers w1, and w2 covered by FSR3. A triplet of control signals determines the fine-tuned wavelength being sampled. In the case of opto-electric tunable filters, such a triplet of control signals is a triplet of control voltages.

In certain preferred embodiment, more than three tunable filters are used. All filters used are well-matched with each other and well calibrated to achieve desired high resolution within a wide spectral range, in a manner that is achievable by an ordinary person skilled in the art.

In a preferred embodiment, a spectroscopic system includes: a first tunable filter module, a second tunable filter module, an optical detector and a signal processing unit. The first tunable filter module includes a first tunable filter and corresponding control unit. The second tunable filter module includes a second tunable filter and corresponding control unit. The second tunable filter is configured in series with the first tunable filter, and the second tunable filter is selected so that the free spectral range of the second tunable filter matches the half-peak width of the first tunable filter. The optical detector is configured to receive wide wavelength bands of electromagnetic radiation transmitted through the first tunable filter and the second tunable filter and to generate one or more electrical signals indicative of electromagnetic radiation intensity as a function of wavelength. The signal processing unit is in communication with the first tunable filter module, the second tunable filter module and the optical detector and is operative to process control information of the first tunable filter to be sent back to the control unit of the first tunable filter module, and the control information of the second tunable filter to be sent back to the control unit of the second tunable filter module, and the detected target radiation information to produce electromagnetic radiation intensity as a function of wavelength.

In a preferred embodiment, a spectroscopic method for processing information collected from the spectroscopic system includes the steps of comparing a target wavelength with calibration table to produce a first control signal for the first tunable filter and a second control signal for the second tunable filter; applying the first control signal to the first tunable filter; applying the second control signal to the second tunable filter; obtaining light intensity signal from the optical detector; repeating the above steps for all wavelengths in the range; and constructing target spectrum from obtained wavelength and intensity information.

Elements of embodiments described with respect to a given aspect of the invention may be used in various embodiment of another aspect of the invention. For example, elements of the various embodiments of the spectroscopic system described herein may be used in the spectroscopic method described herein, and vice versa.

### BRIEF DESCRIPTIONS OF THE DRAWINGS

In the accompanying drawings, reference characters refer to the same parts throughout the different views. The drawings are not necessarily to scale; emphasis has been placed upon illustrating the principles of the invention. Of the drawings:

FIG. 1(a) illustrates the general conceptual flow chart, in FIG. 1(a).A, [Λₘᵢₙ, Λₘₐₓ] is the target wavelength range to be measured, which is divided and sampled on n different wavelength values λ₁, as illustrated in FIG. 1(a).B, a higher n value makes higher resolution possible. Then said n different wavelength values 80 ₁ are fed into the spectrometer disclosed in the present invention, a highly sensitive photo detector, for example, a photomultiplier, is utilized to collect n corresponding power values for each wavelengths sampled, as illustrated in FIG. 1(a).C. Then a high resolution spectrum is reconstructed, as in FIG. 1(a).D.

FIG. 1(b) illustrates our inventive method to achieve high resolution by using a wide range element and a high finesse element. The wide range element 101 is utilized to scan the whole target spectrum, 104, while the high finesse element 102 is tuned to finely scan current pass band to obtain high resolution data within that band, 106. When the high resolution data is collected within that band, 105, wide range element 101 is tuned to cover a different band. This process repeats to cover the whole spectrum range, then computation element 103 reconstructs high resolution spectrum, 107.

FIG. 2(a) illustrates one exemplary embodiment, in which a rotating dispersive element 203 is utilized as wide range element, and a tunable filter 202 is utilized as high finesse element.

FIG. 2(b) illustrates the structure of calibration tables, and how the tables are utilized to determine V_{c}.

FIG. 2(c) illustrates another exemplary embodiment, in which another wider range tunable filter is utilized as wide range element. In this embodiment, two calibration tables are checked to determine two tuning voltages, V_{c} and U_{c}, for corresponding filters.

### DETAILED DESCRIPTION

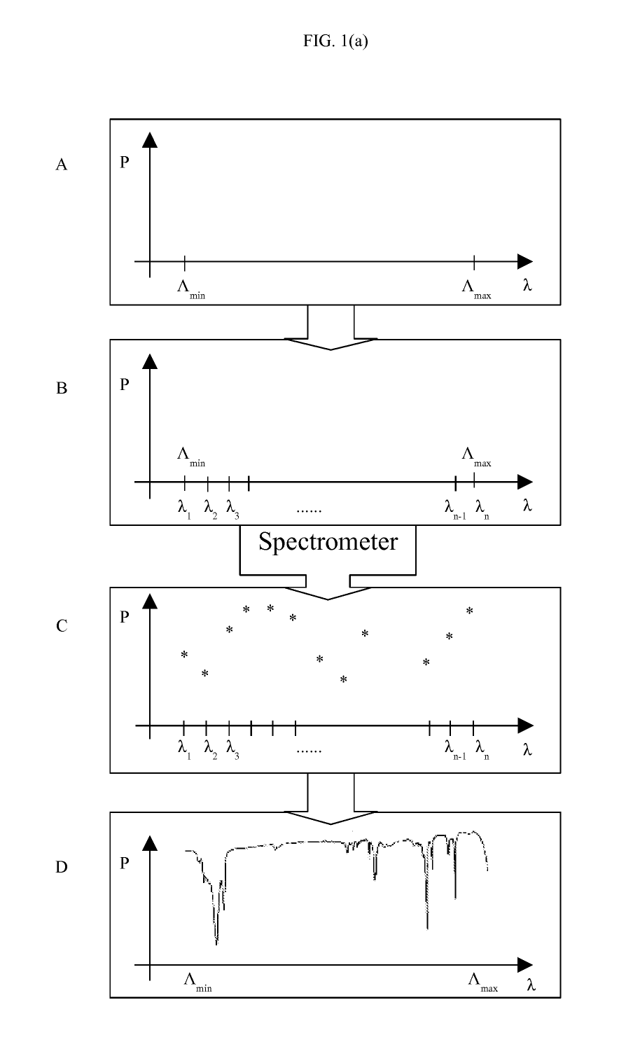

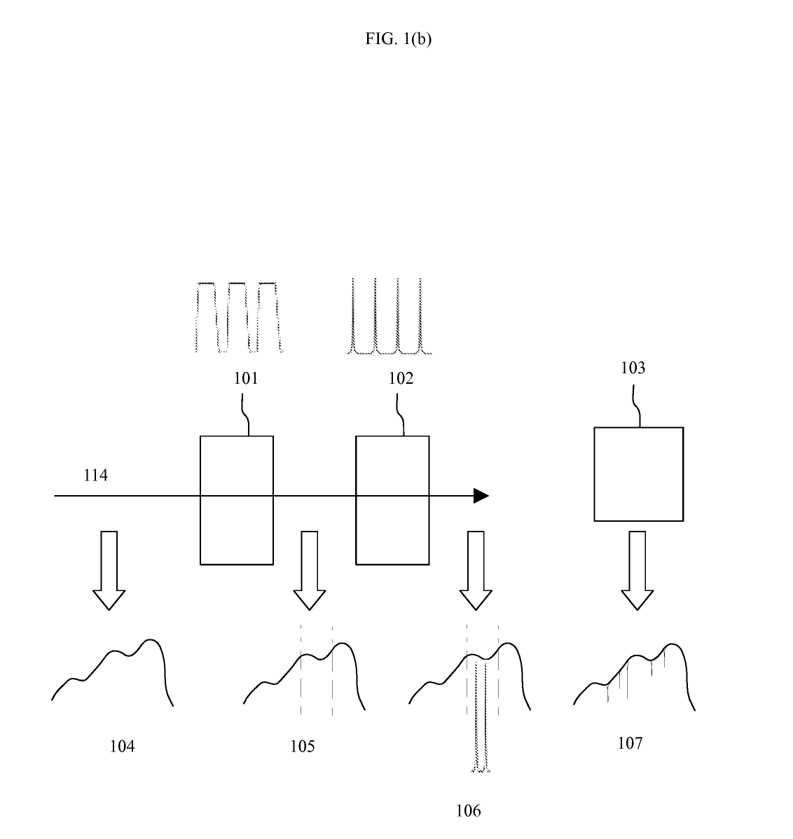

The goal of a spectrometer is to determine the function P=f(λ), where P is the power detected by a detector for wavelength λ. In the present invention, we disclose an inventive method to obtain high resolution spectroscopic data by accurately locating λ and collecting corresponding P value using a highly sensitive photon detector. The general conceptual flow chart is illustrated in FIG. 1(a), in FIG. 1(a).A, [Λₘᵢₙ, Λₘₐₓ] is the target wavelength range to be measured, which is divided and sampled on n different wavelength values λ₁, as illustrated in FIG.

1(a).B, a higher n value makes higher resolution possible. One of the inventive steps disclosed in our present invention is to achieve high n value, for example, by using high finesse tunable filter. Then said n different wavelength values λ₁ are fed into the spectrometer disclosed in the present invention, a highly sensitive photo detector, for example, a photomultiplier, is utilized to collect n corresponding power values for each wavelengths sampled, as illustrated in FIG. 1(a).C. Then a high resolution spectrum is reconstructed, as in FIG. 1(a).D.

One of the inventive steps disclosed in the present invention involves finely dividing the wavelength, which is usually achieved by high finesse devices, such as a high finesse tunable filter. Typically, such a high finesse device has a drawback of narrow range, which typically is not wide enough to cover target wavelength range to be measured. Another inventive step is disclosed in the present invention to remedy the narrow range of the high finesse element, which is a wide range element 101 as illustrated in FIG. 1(b). The wide range element 101 is utilized to scan the whole target spectrum, 104, while the high finesse element 102 is tuned to finely scan current pass band to obtain high resolution data within that band, 106. When the high resolution data is collected within that band, 105, wide range element 101 is tuned to cover a different band. This process repeats to cover the whole spectrum range, then computation element 103 reconstructs high resolution spectrum, 107.

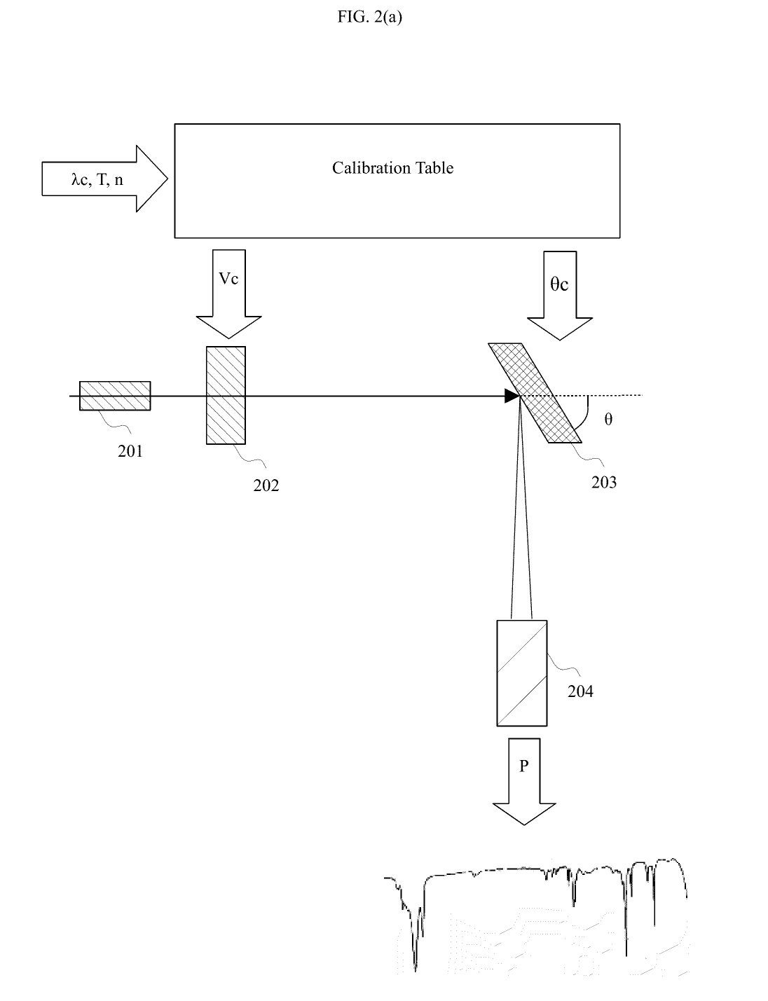

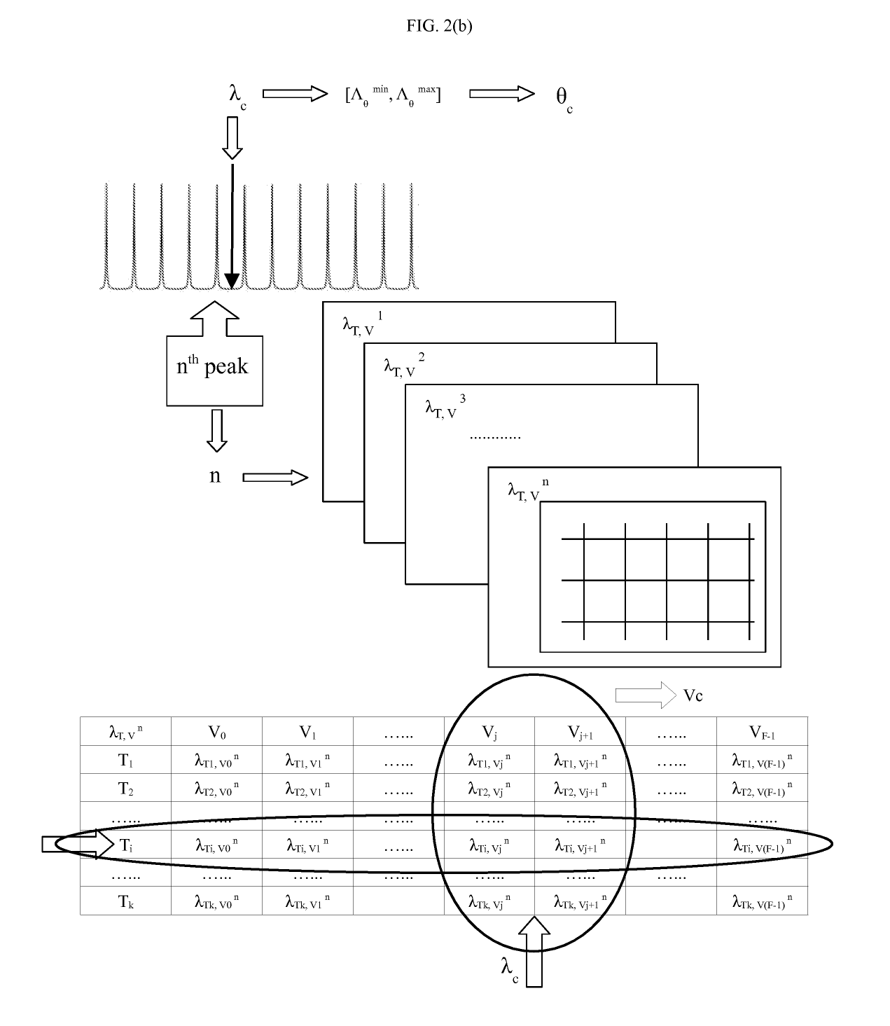

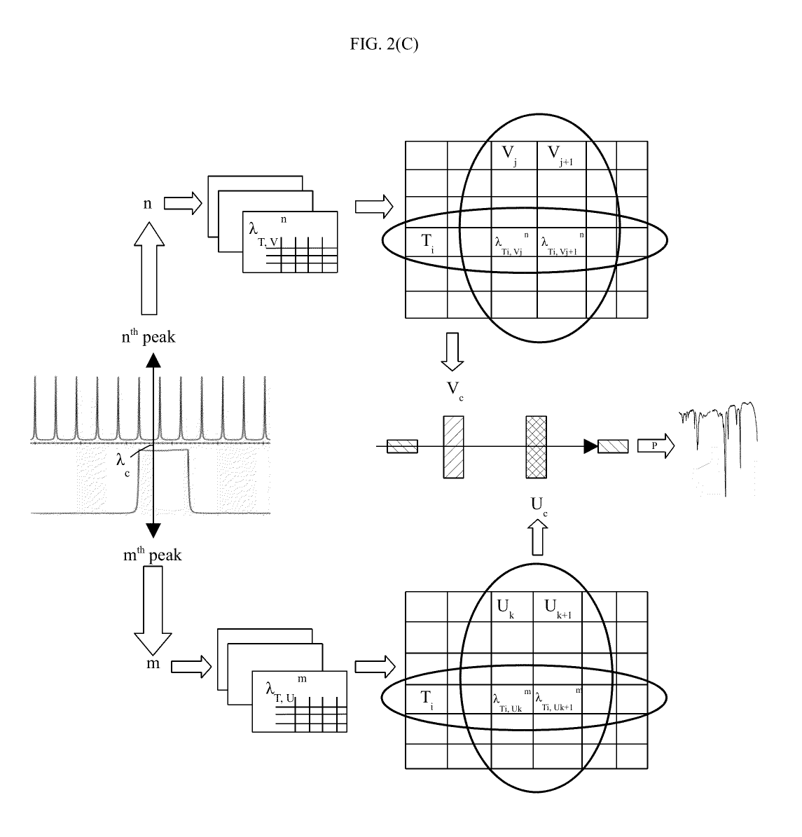

One exemplary embodiment is illustrated in FIG. 2(a) and FIG. 2(b). Incident light comes out of light source 201, and then is passed through a high finesse element, a high finesse tunable filter 202, then to a rotating dispersive element 203 as wide range element. The present invention does not claim instruments with dispersive, or rotating dispersive, elements, however, this embodiment is helpful in understanding another embodiment illustrated in FIG. 2(C) and the method generally. A high sensitivity photon detector 204 collects power data used to reconstruct high resolution spectrum. The λ values at which P is measured are determined by the property tunable filter 202, which is carefully selected and calibrated. Each λc is fed into a calibration table together with current environmental temperature T to determine tuning control variables V_{c}, which is the tuning voltage of 202, and θ_{c}, which is the rotating angle of 203. The value n, which is determined by counting the number of peaks on the left of current λ_{c} of the transmission property curve of 202, is also needed to be fed into the calibration table, as illustrated in FIG. 2(b).

Typically a step motor is utilized for 203, for each θ, only a narrow band of λ can be received by photo detector 204, that narrow band is [Λ_{θ}^{min}, Λ_{θ}^{max}]. A calibration table is produced for each θ when the spectrometer is made, so for each λ_{c}, a narrow band [Λ_{θ}^{min}, Λ_{θ}^{max}] which contains λ_{c} can be found in the table, and accordingly, a corresponding θ_{c} can be determined.

The tunable filter 202, when selected, is also calibrated with different working temperature T, tuning voltage V for each peak in the transmission property curve. Calibration tables are produced for each tunable filter used in the spectrometer. The number of calibration tables for each tunable filter is equal to the number of peaks in the transmission property curve. In the table for the n^{th} peak, λ_{T},V, n in each temperature row T, it records the position of the n^{th} peak in terms of wavelength λ when the tuning voltage applied to the filter is V. Extrapolation can be conducted to fill missing values. Alternatively, fitting curve functions can be calculated, with variables T, V and n.

For each λ_{c} at temperature Tᵢ, V_{c} can determined by checking the T^{th} row of the n^{th} calibration table of the filter, where a range [λ_{Ti, Vj}ⁿ, λ_{T}, Vj+1ⁿ] that contains λ_{c} can be located. An extrapolation on the corresponding range [Vⱼ, Vⱼ₊₁] can determine V_{c}.

When both control variables θ_{c} and V_{c} are determined, they are applied to corresponding elements, V_{c} to 202, θ_{c} to 203, and a power value P_{c} is read in 204. (λ_{c}, P_{c}) becomes a data point on the resulting spectrum, this step is repeated until all data points are collected. A high resolution spectrum is produced.

FIG. 2(C) is another exemplary embodiment, where the wide range element is another tunable filter with wider range, which is carefully selected and matched. Now instead of checking one tunable filter calibration table, two tables are checked to determine two different tuning voltages, V_{c}, U_{c}, for each tunable filter. When V_{c} and U_{c} are applied to corresponding filters, P_{c} is recorded by the high sensitivity photon detector for corresponding λ_{c}.

Calibration tables reflect the physical property of a tunable filter, transmission peak positions are recorded when the tuning voltage is changed at certain temperature. While the calibration features of a tunable filter remain the same, there are different ways to make calibration tables. One example is to make a table for each peak in the transmission property curve, if there are n peaks, there are n tables. Within each table, temperature is increased by small steps, at each temperature, tuning voltage is increased by small steps from 0, at each temperature and tuning voltage, peak position is recorded. Smaller temperature steps and voltage steps increase accuracy of calibration; polynomial fitting curves (surfaces) can also be made to replace the tables. Calibration functions might be more efficient in certain applications.

Calibration of Tunable Filter 202:

A calibration table is usually produced for tunable filter 202 for different temperatures, which cover the target working environment temperature range, and different tuning voltages, which cover the full free spectral range.

Assume the free spectral range of 202 is FSR, the half peak width of 202 is w, then the finesse of 202 is F=_{┌}FSR/w_{┐}, which means the smallest integer no smaller than FSR/w.

Assume the target working environment temperature range is [Tₘᵢₙ, Tₘₐₓ], which is evenly divided into k−1 steps to obtain calibration data with Tₘᵢₙ=T₁, Tₘₐₓ=Tₖ. When the actual working temperature T falls in between T₁ and Tᵢ₊₁, usually a linear extrapolation is conducted to obtain corresponding calibration data.

The following table is an example of one of such calibration tables for the i^{th} peak of tunable filter 202. The calibration process yields n such calibration matrix, one for each of the n peaks of tunable filter 202.

Calibration Table #i:

| λ_{T,V}ⁱ | V₀ | V₁ | V₂ | V₃ | . . . | V_{F-1} |
|---|---|---|---|---|---|---|
| T₁ | λ_{T1,V0}ⁱ | λ_{T1,V1}ⁱ | λ_{T1,V2}ⁱ | λ_{T1,V3}ⁱ | . . . | λ_{T1,V(F-1)}ⁱ |
| T₂ | λ_{T2,V0}ⁱ | λ_{T2,V1}ⁱ | λ_{T2,V2}ⁱ | λ_{T2,V3}ⁱ | | λ_{T2,V(F-1)}ⁱ |
| T₃ | λ_{T3,V0}ⁱ | λ_{T3,V1}ⁱ | λ_{T3,V2}ⁱ | λ_{T3,V3}ⁱ | | λ_{T3,V(F-1)}ⁱ |
| . . . | | | | | | |
| Tₖ | λ_{T3,V0}ⁱ | λ_{Tk,V1}ⁱ | λ_{Tk,V2}ⁱ | λ_{Tk,V3}ⁱ | | λ_{Tk,V(F-1)}ⁱ |

Calibration of Rotating Grating 203:

For each θ in FIG. 2(b), the wavelength range received by detector 204 is [Λ_{θ}^{min}, Λ_{θ}^{max}]. Put the motor in park position, and set θ to 0, [Λ₀^{min}, Λ₀^{max}] is calibrated. Typically a high precision step motor is utilized for 203, in which case θ take discrete values. For additional θ values, [Λ_{θ}^{min}, Λ_{θ}^{max}] is calibrated.

What is claimed is:

1. A spectroscopic system comprising:
a first tunable filter module comprising a first tunable filter and corresponding control unit, wherein the first tunable filter optically filters a signal from a sample;
a second tunable filter module comprising a second tunable filter and corresponding control unit, wherein the second tunable filter optically filters a signal from the first tunable filter, wherein the second tunable filter is configured in series with the first tunable filter, and the second tunable filter is selected so that the free spectral range of the second tunable filter matches the half-peak width of the first tunable filter;
an optical detector configured to receive wide wavelength bands of electromagnetic radiation transmitted through the first tunable filter and the second tunable filter and to generate one or more electrical signals indicative of electromagnetic radiation intensity as a function of wavelength; and
a signal processing unit in communication with the first tunable filter module, the second tunable filter module and the optical detector and operative to process control information of the first tunable filter to be sent back to the control unit of the first tunable filter module, and the control information of the second tunable filter to be sent back to the control unit of the second tunable filter module, and the detected target radiation information to produce electromagnetic radiation intensity as a function of wavelength.

2. The spectroscopic system of claim 1, wherein the tunable filters are Fabry-Perot interference filters.

3. The spectroscopic system of claim 1, wherein the tunable filters are birefringent filters.

4. The spectroscopic system of claim 1, wherein the tunable filters are acousto-optic filters.

5. The spectroscopic system of claim 1, wherein the tunable filters are micro-electro-mechanical system Fabry-Perot tunable filters that are electrically driven.

6. The spectroscopic system of claim 1, wherein the tunable filters are Fabry-Perot filters that are tunable by changing a temperature of the tunable filters.

7. The spectroscopic system of claim 1, wherein the tunable filters are tunable liquid crystal filters.

8. The spectroscopic system of claim 1, wherein the first tunable filter is a tunable Lyot filter, and the second filter is a tunable Fabry-Perot filter.

9. A spectroscopic method for processing information collected from the spectroscopic system in claim 1, the method comprising the steps of:
comparing a target wavelength with calibration table to produce a first control signal for the first tunable filter and a second control signal for the second tunable filter;
applying the first control signal to the first tunable filter;
applying the second control signal to the second tunable filter;
obtaining light intensity signal from the optical detector;
repeating the above steps for all wavelengths in the range; and
constructing target spectrum from obtained wavelength and intensity information;
